(19) United States
(12) Patent Application Publication
(10) Pub. No.: US 2026/0148494 A1
(43) Pub. Date: May 28, 2026

(54) System and Methods Using Guided Scanning for Generating 3D Models

(71) Applicant: ECLO, INC., Mountain View, CA (US)

(72) Inventors: Alex Villanueva, Cupertino, CA (US); Liangjia ZHU, Menlo Park, CA (US); Patryk ZOLANSKI, Torun (PL)

(21) Appl. No.: 18/423,275

(22) Filed: Jan. 25, 2024

Related U.S. Application Data
(60) Provisional application No. 63/441,138, filed on Jan. 25, 2023.

(51) Int. Cl. G06T 17/20

(52) U.S. Cl. CPC G06T 17/20

(57) ABSTRACT

Methods and systems for capturing images of an object such as a foot with a handheld mobile device capable of performing depth scanning including providing guidance to the operator of the scanner in the form of one or more of visual, haptic and auditory feedback so as to capture sufficient images of the object that a virtual three-dimensional representation of the object can be generated.

### RELATED APPLICATIONS

This application is a conversion of U.S. patent application Ser. No. 63/441,138, filed Jan. 25, 2023, which is incorporated herein by reference. Also incorporated herein by reference is U.S. patent application Ser. No. 17/898,326 filed Aug. 29, 2022 and U.S. Pat. No. 10,841,486.

### FIELD OF THE INVENTION

The present invention relates generally to methods and systems for capturing images of an object such as a foot with a handheld scanner and providing guidance to the operator of the scanner in the form of one or more of visual, haptic and auditory feedback so as to capture sufficient images of the object that a virtual three-dimensional representation of the object can be generated.

### BACKGROUND OF THE INVENTION

One of the major challenges faced by online retailers is providing buyers with reasonable assurance that the item they decide to buy will meet their needs. This challenge particularly impacts online retailers of clothes, including shoes. According to some surveys, nearly half of all customers who bought shoes online have returned at least one pair.

In part, this high rate of return for online purchases of shoes relates to the uniqueness of each human foot, where some of the common anomalies are: flat-footed, high arch, narrow ankle but broad forefoot, hammer toe, bunions, and so on. Volume-produced footwear simply does not take into account the variability of the human foot, and instead typically uses a last that basically represents a generic foot. The fit of a shoe is completely dependent on the shape and volume of the shoe last. Different style shoes use different lasts, and typically the last for each style and size of a particular shoe varies with each manufacturer. Whether a particular shoe will fit a specific consumer is completely dependent on the shape and volume of that shoe's last.

Attempting to successfully match a particular human foot to a shoe in an online transaction thus presents significant challenges. One approach to achieve better matches is to create a digital model of the foot, as taught by commonly-owned U.S. Pat. No. 10,841,486 incorporated herein in full by reference. Such a digital model permits a consumer to try on shoes virtually and significantly improves the ability of online shoppers to know what size, design and manufacturer will fit them best.

While a digital model offers significant benefits for online purchasers as well as online retailers and manufacturers, the historical challenges to producing such a digital model have been significant. While the method and system taught in the '486 patent referenced above has solved many of the challenges through the guided use of a camera on a smartphone or similar mobile device, several challenges remain that, if resolved, would improve the user experience and yield more rapid and accurate results. Among them are the desire for improved auditory and/or haptic feedback to the user while scanning the foot, the ability to create the digital model in the mobile device substantially in real time, the ability to provide a more intuitive representation of both completed scans and regions remaining to be scanned.

Recently, at least some smartphones have included depth sensing technology in one form or another, typically for face recognition or for performing relatively gross measurements such as the dimensions of a room or the relative locations of objects in a room or other space. These depth sensors take a variety of approaches, for example structured light, time of flight (including LiDAR implementations), or stereo vision. Typically these devices operate by projecting some wavelength of RF signal, for example infrared light which may be pulsed, onto a subject and detecting the signals reflected back from the subject. The detected signals can then be processed to create a point cloud or other depth map. These same techniques can also be implemented on a variety of handheld devices, with smartphones comprising one common example.

One approach taken by a well-known manufacturer of such devices for use in facial recognition is to project onto a user's face an array of several tens of thousands of dots and, based on the reflected signals, compare at least key characteristics of the current depth map to previously identified characteristics from a depth map created at the time of device registration. In the case of smartphones, such depth sensors are generally located on the same side of the phone as the display, which is useful for facial recognition but problematic for scanning feet. A user seeking to use a smartphone's depth sensor to scan their feet must face the display away from their face while performing that scan. The inability of users to look at the screen while scanning makes for an unsatisfying user experience and a likelihood of inaccurate or incomplete scans despite repeated efforts.

Even were the depth sensor on the opposite side of the handheld device from the display, guiding the user to position the depth sensor is not straightforward. The device must be moved at the positions (x, y, z) and at the right angle (pitch, roll and yaw) in the 3D space surrounding the object in order for the device to be in the right locations relative to the foot while aiming at the right area.

From the foregoing, it can be appreciated that there has been a long-felt need for a system implemented on a handheld or other mobile device such as a smartphone which provides an intuitive, easy-to-use interface for performing scans of a user's feet that result in the generation of a digital 3D model of a user's feet at a level of accuracy that enables substantially reliable estimations of types of shoes that will fit that user. By achieving that goal, the online shopping experience is significantly improved for both the customer and the vendor.

### SUMMARY OF THE INVENTION

The present invention substantially resolves the aforementioned challenges in a manner which enables users to take scans of their feet with sufficient accuracy that adequate geometric information around the foot is captured to create a 3D geometry of the foot that is an accurate representation of the foot in both shape and dimension. The scan typically comprises a sequence of frames of data as the mobile device is moved around the foot, with those frames of data processed in the mobile device to form a point cloud or other 3D representation of the foot. An intuitive interface for guiding the user during scanning is provided through the use of a plurality of distinctive forms of audible and haptic feedback.

Further, should the user choose to stop scanning to check their progress, a display is provided that shows a representation of what portions of the foot have been scanned and what portions of the foot remain to be scanned. In at least some implementations, a rotation of the mobile device beyond a threshold is detected and turns off scanning, thus informing the system to process the frames captured up to that point and generate as much of a 3D representation of the foot as possible at that stage. Alignment of the images is performed by any suitable method, for example ICP.

To provide context, in order to enable the user to initiate scanning, either at the beginning or following any interim stops, a generic representation of a foot is displayed on the user device. Data from the depth sensor is used to provide at least an estimate of the portions of the foot that have been scanned so far. That estimate is overlaid on that generic representation of the foot to provide substantially anatomically correct visual feedback to the user showing at least approximately the portions of the foot that have been successfully scanned and, in contrast, the portions that remain to be scanned. In some embodiments, general data about the user's foot may be provided before generating the generic representation, for example the user's shoe size, so that the generic representation of a foot reasonably depicts some basic features of the user's foot. As more frames are processed from successive scans, the overlay provides an increasingly complete point cloud of the scanned foot.

In at least some embodiments, in addition to the visual feedback of the generic foot and an overlay of any portions already scanned, a series of indicia are shown on the display, essentially forming a ring around the generic foot image. In some embodiments, the indicia showing completed portions of a scan are one color or shape or other characteristic, and indicia showing portions remaining to be completed are a different color or shape or other characteristic.

After the user has reviewed the display, scanning restarts when the user again points the depth sensor portion of the mobile device at the foot. Auditory and haptic feedback signals the user to adjust not only position in terms of x, y and z, but also pitch, yaw and roll. Once the position of the depth sensor is within a predetermined threshold, scanning restarts and continues until either the scan is completed or the user again stops the scan, for example by again turning over the device to view the display.

When all regions of the foot have been successfully captured, feedback to the user confirms that the user portion of the process is complete. In at least some embodiments, to avoid confusing the user the characteristics of the feedback vary from the feedback provided at other steps in the scanning process.

It is therefore one object of the present invention to provide an intuitive user interface that enables a user to perform scans of a foot sufficient to develop a digital 3D model of that foot.

It is a further object of the present invention to provide one or more of visual, audible and haptic signals as feedback to the user to guide the user's scan of a foot.

It is a still further object of the present invention to automatically generate guidance by which a user orients a mobile device including a depth sensor relative to a foot in three dimensions.

It is yet another object of the present invention to automatically orient pitch, yaw and roll of a mobile device including a depth sensor relative to a foot to enable scanning of the foot.

A still further object of the present invention is to automatically detect distance from an object such as a foot and to provide guidance to a user to assist the user in placing the mobile device within a range of distances wherein substantially accurate scanning can be performed.

It is a still another object of the present invention to provide a generic digital model of a user's foot for display to a user as a guide, and then modify that model with an estimation of areas of the foot that have been successfully scanned.

Yet another object of the present invention is to provide a visual presentation of differing indicia to permit a user to rapidly distinguish regions of a foot that have been successfully scanned from regions that have not been successfully scanned.

Still another object of the present invention is to provide a method and system for automatically identifying the location of a foot by identifying data clusters in images sensed by a depth sensor.

These and other objects of the present invention can be better appreciated from the following detailed description of the invention, taken in conjunction with the appended figures as described below.

### FIGURES

FIGS. 1A-1B illustrate in flow diagram form and block diagram form, respectively, an embodiment of a generalized data flow and the associated processing blocks that execute the functions of the present invention shown in greater detail in FIG. 2.

FIG. 2 illustrates in flow diagram form an embodiment of the software application that executes on the system of FIGS. 1A-1B to guide a user in scanning a foot, capturing depth sensed images from that scan, and developing a representation of a foot sufficient to create a digital model of a foot to assist in a virtual try-on of shoes by a user.

FIG. 3A-3C depict different views of the point cloud from a single frame in accordance with an embodiment of the invention.

FIGS. 3A-3C depict an embodiment of a display of a mobile device wherein FIG. 3A shows a time when the user is looking at the display, FIG. 3B shows the display at the start of a scan, and FIG. 3C shows the display during scanning.

FIGS. 4D-4E depict the point clouds resulting from the alignment of the point clouds from three frames taken from different viewpoints in accordance with an embodiment of the invention.

FIGS. 5A-5C depict an embodiment of the display of a mobile device that provides visual feedback in the form of estimations of the portions of a foot that have been scanned, wherein FIGS. 5A-5C provide top, right side and left side views, respectively, at an intermediate stage of scanning.

FIGS. 5D-5E depict an embodiment of the display of a mobile device at a later stage of scanning, showing top and back views, respectively of the representation of the foot being scanned to provide visual feedback to the user.

FIG. 5F depicts an embodiment of the display of a mobile device once scanning has been successfully completed and the system is generating the resulting digital model.

FIGS. 6A-6C depict an embodiment of the display of a mobile device showing top, right side and left side views of the scan results in point cloud form.

FIGS. 6D-6F depict an embodiment of the display of a mobile device showing top, right side and left side views of the mesh that results from the completed scans once processed in accordance with FIG. 2.

### DETAILED DESCRIPTION OF THE INVENTION

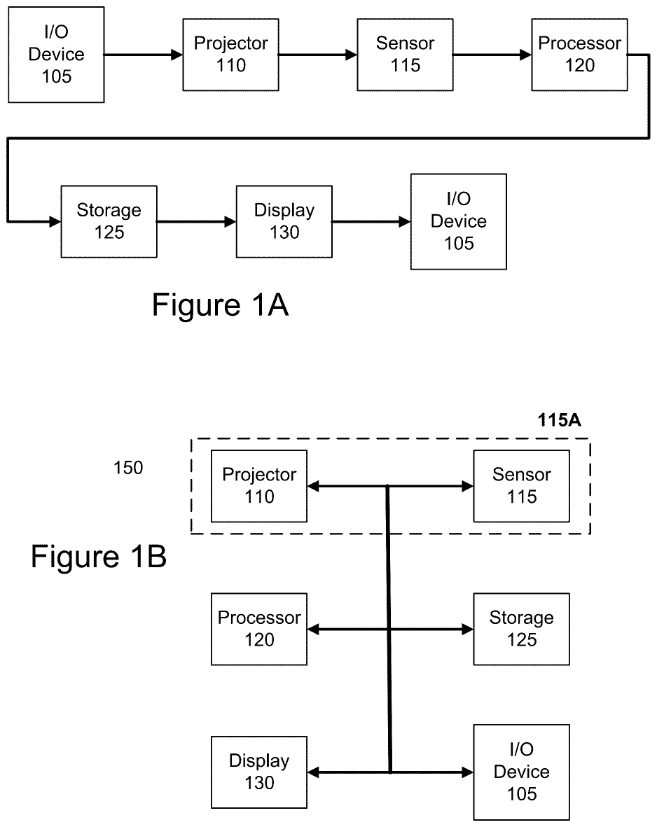

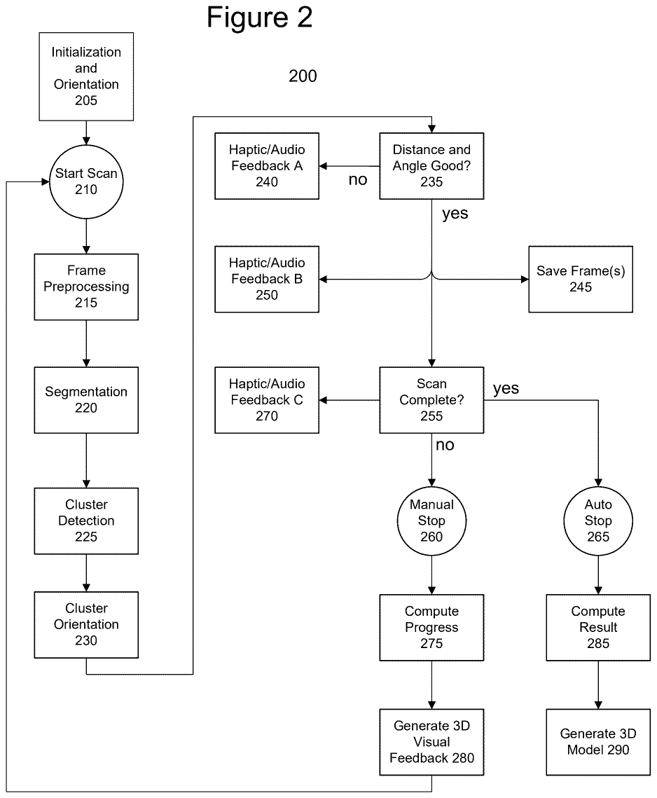

Referring first to FIGS. 1A and 1B, an overview of the operation of an embodiment of the invention can be appreciated. FIG. 1A shows a generalized view of an embodiment of the data flow through each block of the system, where a generalized view of the overall system is shown in FIG. 1B. The general operation of FIGS. 1A and 1B enables a user to perform a guided scan of an object such as a foot to cause the generation of a digital 3D model of the object, e.g. a foot, where an embodiment of the process of the guided scan is shown in the flow diagram of FIG. 2. It will be appreciated that the flow diagram of FIG. 2 represents program code that executes on the platform of FIG. 1B. In an embodiment, the code represented by FIG. 2 is an application that resides on a smartphone or similar mobile device. For purposes of simplicity and clarity, references herein to “mobile device” are intended to include smartphones such as those from Apple, Samsung, and other manufacturers. Apple and Samsung are trademarks of their respective companies.

Continuing with regard to FIGS. 1A and 1B, the application of FIG. 2, indicated broadly at 100 in FIG. 1A, is started by a user selecting that application via an I/O device or interface 105 on the mobile device indicated broadly at 150 in FIG. 1B. At a high level, once the application, typically stored in storage 125, begins executing in a processor 120, it causes a projector 110 and sensor 115 to operate to capture images of at least some of the space within the field of view of the sensor 115. In at least some embodiments, the combination of the projector 110 and sensor 115 comprise a depth sensor device 115A, where the sensor 115 is often referred to in the field as a camera. That term will be used from time to time herein and may, depending upon context, refer to the combination of the projector and sensor. In at least some embodiments, the projector 110 will output signals, typically in the infrared frequency range, that strike an object of interest such as a foot and are reflected back to the sensor 115 where the captured light comprises an image. Such devices typically operate using one or more of structured light, time of flight, stereo vision or similar techniques to permit the system to determine how far particular points on the object of interest are from the depth sensor 115A. The images captured by the sensor are processed in the processor 120 and associated storage 125 in a manner known in the art to provide a point cloud of the object of interest, e.g., a foot. Alternatively, in some embodiments the captured data can be stored and provided to an external system for processing. In either approach, the resulting point cloud can be displayed on the screen or other display 130 of the mobile device, and the final output of the application can be provided to a user via the I/O device 105 or by being shown on the display 130.

With the foregoing overview in mind, the process shown in FIG. 2 can be better appreciated, where the overall application is indicated at 200. FIG. 2 shows in flow diagram form an embodiment of the processing steps necessary to guide a user in performing a scan of an object such as a foot and then processing the results of that scan to generate a digital three-dimensional model that accurately represents key anatomical features of an object such as a foot, including length, width, height, and so on. Once such a digital model is generated, that model can be matched to the interior space of a shoe to determine whether that shoe represents a good fit for that foot, or can be used to provide orthotics, to analyze gait or other physical conditions, and so on.

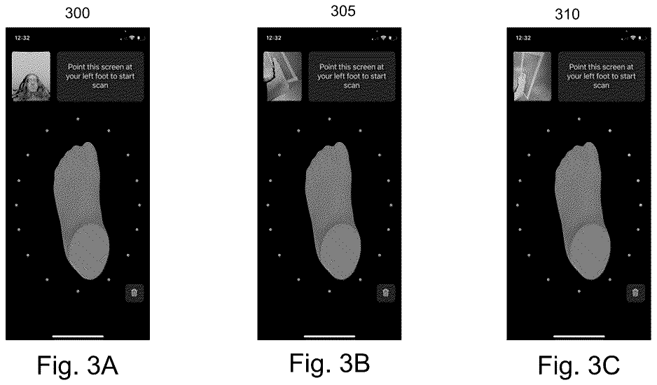

From a user's perspective, an embodiment of the scan process of the invention starts by the user initializing the application 200. Unknown to the user, when the user starts the application, an embodiment begins with an initialization and orientation subprocess indicated at 205. The subprocess 205 performs a partial scan so that the system of the invention knows at least at a gross level the location and orientation of the foot relative to the phone. In an embodiment, an assumption is made that, when the user starts the application, they will have their smartphone or other device in the position shown in FIG. 3A, where the user can see the screen. Likewise, an assumption can also be made that the phone is substantially parallel to the foot. The combination of these assumptions gives a general orientation of the foot relative to the phone. It will be appreciated that these assumptions also apply when a user looks at the display to check their scanning progress, where the image on the display provides visual progress feedback.

That orientation information is then refined by performing a partial scan, essentially the steps 215-230 of FIG. 2 but without moving the mobile device, where the resulting images are analyzed in the processor to look for a large cluster of points in the recorded frames. If a cluster of points significantly larger than its surrounding is detected, it is labeled as the foot. Alternatively, machine learning techniques can be used where the neural network used in such an approach is trained to recognize a foot. Still further, the front facing camera of the mobile device can be used to obtain at least the gross position of the foot and in some embodiments can detect both objects and depth data. By any of these techniques, once the general location of the foot has been identified, the app 200 executing on the platform 150 has the orientation and position of the foot relative to the phone, which permits scanning to begin. Auditory or haptic guidance can also be used to help the user orient the mobile device at this preliminary stage. In at least some embodiments, the user is instructed to ensure that the foot being scanned is flat on the floor or other surface.

To begin scanning, in an embodiment the user directs the depth sensor device, typically integrated into the mobile device, toward the foot and initiates scanning either by a physical movement, a spoken command, or other forms of user input. If necessary, such as devices where the depth sensor 115A is on the same side of the phone as the display, the user is directed to flip the mobile device over so that the depth sensor 115A is directed at the foot. Optionally, a countdown timer may be provided where the user has a few seconds to flip or otherwise reposition the mobile device so that the device's display is as shown in FIG. 3B before actual scanning is initiated. An audio, haptic or visible countdown can be used in some embodiments, together with a sound or other user-perceptible indicia to indicate scanning is starting. In some embodiments, where the mobile device includes an inertial measuring unit [not shown], the app 200 can use the output from that inertial measuring unit (IMU) to determine if the phone is in scanning position. When the phone's orientation (some or all of x, y and z position as well as pitch, roll and yaw) meets predetermined thresholds, the scan countdown begins. Regardless of the technique by which this beginning orientation is achieved, after the countdown is complete the phone starts to record frames.

Scanning proceeds by moving the phone around the foot while pointing the depth sensor at the foot, as shown in FIG. 3(c). Audio and haptic feedback is given to the user to make sure the depth sensor is pointing at the foot and that the phone is kept at an acceptable distance from the foot. As noted above, the primary objective during a scan is that enough frames are recorded from appropriate orientations around the foot that a digital model of the foot can be successfully generated, as discussed hereinafter.

The process of FIG. 2 does not require that the mobile device be moved to exact positions or orientations. Instead, as long as the mobile device stays within a set of ranges, a successful scan can be performed. Thus, for a successful scan, the mobile device orientation relative to the foot and the mobile device distance from the foot will meet a predetermined criteria that will depend upon the particular mobile device and the characteristics of the distance sensor 115A used in that device.

The orientation and distance of the mobile device relative to the foot is monitored by the processor during movement of the mobile device past the foot while steps 215-230 of FIG. 2 are automatically performed as discussed below. In an embodiment, shown at step 210, the scanning operation generates a stream of data from (1) the depth sensor camera and (2) an inertial measuring unit (IMU) integrated into the mobile device, such as the MEMS-based IMU's integrated into smartphones. The camera data is typically organized as frames while the IMU data is typically sent to the processor at a faster rate. In an embodiment, the two are synchronized by sampling the latest IMU data at the time of the camera frame capture. The IMU can be used to provide an indication of the orientation of the mobile device to detect when the device is in position to scan, as discussed above, such as within a range of angles facing the floor. In some embodiments, the range can be between +90 and −90 degrees with the particular range set as a threshold. In embodiments where a scan countdown is implemented, when the mobile device's orientation passes the threshold, the scan countdown begins and scanning is initiated when the countdown completes. Alternatively, the scan be manually initiated by voice or touch, by a machine learning algorithm trained to identify the foot, or any other suitable methodology.

Then, as shown at step 215, frame pre-processing is performed. In an embodiment, such pre-processing involves converting the synchronized depth maps and color frames received from the camera and IMU into RGB-D images. The RGB-D images are then converted into 3D point clouds, for example by using the camera intrinsic matrix. It will be appreciated by those skilled in the art that cameras map a three-dimensional scene onto a two-dimensional sensor. That mapping basically comprises two transformations, first from the world coordinate system to the camera coordinate system, and second from the camera coordinate system to the pixel coordinate system, i.e., the camera's sensor. The first transformation is performed by what can be referred to as the extrinsic matrix, which comprises the location and orientation of the camera in 3D space relative to the subject. The second transformation is performed by what can be referred to as the camera intrinsic matrix, which comprises characteristics specific to the camera including lens focal length, aperture, field of view, resolution, noise, and so on. For RGB-D cameras, the camera intrinsic matrix converts the depth map and color data of an RGB-D image into a 3D point cloud or voxel grid suitable for the next step in the process shown in FIG. 2, segmentation. In some embodiments, the point cloud is downsampled to a smaller resolution for computational efficiency because of processor performance limitations. In embodiments that permit GPU processing of the RGB-D image or otherwise have a sufficiently fast processor, downsampling may not be required and raw depth maps can be processed in substantially real time or at least fast enough to provide visual, haptic and/or auditory feedback that the user perceives the operation as substantially continuous, with no delays that cause the user to become concerned enough either to interrupt or discontinue the scan.

To provide a user the guidance to perform a smooth scan of the foot, it is desirable to determine the location and orientation of the foot. In an embodiment, this begins with determining the location of the floor or other surface (e.g., a wall, cupboard door, or other relatively flat surface, whether or not vertical or horizontal) on which the foot is resting. In an embodiment, segmentation, shown at 220, provides separation of the foot being scanned from the background, including particularly the floor or other surface upon which that foot resting. For clarity, the plane upon which the foot rests will be referred to as the “floor” at least sometimes hereinafter. Segmentation can be performed using the semantic segmentation tools available in, for example, Open3D with PyTorch or Tensorflow support, although any of the well known tools for segmentation will also provide acceptable separation of the floor from the foot.

Once segmentation is performed, in an embodiment the location and orientation of the foot is determined by the use of clustering techniques. Cluster detection basically means identifying areas within the point cloud where the points are at a higher density than in surrounding areas; i.e., a cluster can be thought of as a density-connected set of points. While multiple methods for detecting clusters can be used, as known to those skilled in the art, one workable approach is to DBSCAN within Open3D. By establishing the minimum number of points necessary to define a cluster, or “MinPts” value, and also defining the maximum distance between points for them to be part of a cluster, also known as epsilon or “eps”, clusters can be identified within the point cloud. Points within the epsilon value can be either core points or border (or boundary) points, depending upon their proximity or lack of proximity to other points within the cluster.

To identify clusters that help to define the location and orientation of the foot, in an embodiment all points that are, for example, more than five millimeters above the floor and less than twelve centimeters above the floor are extracted from the point cloud images, although the exact distances can vary depending upon foot size, type of shoe being considered, and so on. A MinPts value is applied, for example thirty points, so that groups of points within the distance values that meet the MinPts value are identified as a cluster. Once all clusters in a point cloud image that meet the MinPts and eps values are identified, a best cluster is selected by, for example, choosing the largest clusters, for example the two. If the smaller cluster is reasonably close to the same size as the larger cluster, for example at least one-half the number of points in the larger cluster, then the cluster nearest the camera is defined at the best cluster. It will be apparent that the more than two clusters can be considered in choosing the best cluster, where the determinative criterium can be relative size or any other convenient measure.

With the general location of the foot having been determined from the foregoing cluster detection steps, determining foot orientation is performed next. In an embodiment, the center point of a bounding box around the best cluster is calculated and projected to the floor plane to define the projected foot center. A translation vector is then calculated from the camera principal point and the projected foot center, while a rotation matrix is obtained from the IMU in order to set the Z-axis to point towards gravity with the Y-axis pointing toward magnetic north. The plane of the floor is assumed to be horizontal. The rotation matrix and translation vector are combined into 4×4 transformation matrix that converts the best cluster so that it is set on the floor, with its projected_foot_center set as the coordinate origin.

The suggested shooting angle is formed between a camera vector and the magnetic north vector. The camera vector is the vector between the projected foot center and the camera's principal point, projected onto the floor. The magnetic north vector is a unit vector on the floor plane taken from the origin to a point representing magnetic north. In an embodiment, the user's orientation relative to magnetic north can then be used to compute the shooting angle absolute, which is then saved as the desired angle of the camera relative to the direction the foot is pointing for beginning scanning. While the shooting angle in an exemplary embodiment is just one angle, in alternative embodiments In this implementation, the shooting angle can have additional components (angle, radius, pitch, yaw, etc.) or can be computed relative to the foot instead of magnetic north.

The distance of the camera relative to the best_cluster (e.g. not too close or not too far, with the optimal distance determined by the focusing characteristics of the camera in the mobile device), and shooting angle (e.g. change by ten degrees from the previous position) are monitored. Predefined zones/regions/areas, for example sixteen although both larger and smaller numbers can provide satisfactory results in some cases) are established around the foot. Once a zone has been fully scanned, that zone is considered complete. Auditory, haptic, or visual feedback is provided to inform the user of either a successful scan of a zone or the need to scan some or all of the zone. It will be appreciated that each frame recorded by the app of the invention comprises depth data (point cloud) of a small area of the foot. With enough frames, the entire foot geometry can be reconstructed and a 3D model created.

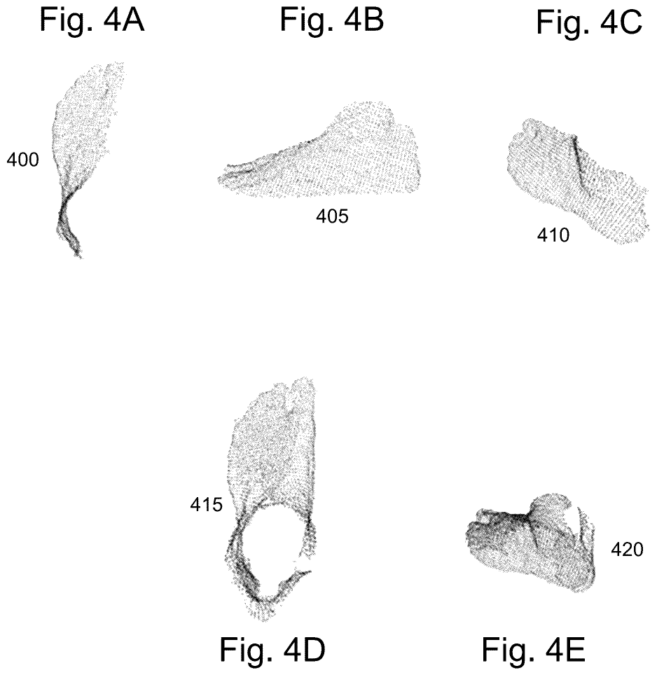

At any point during a scan, the user can check the phone screen to see his scan progress. In an embodiment, this involves turning over the phone to permit the user to see the screen. When the phone is flipped over in this manner, in excess of a predetermined threshold angle, for example ninety degrees, the foot scanning function is automatically paused or terminated. The software application that forms part of the system of the invention causes the processor in the mobile device to calculate the portions of the foot that have been successfully scanned, FIGS. 4A-4E, and then to display on the screen of the mobile device a 3D representation of the foot showing at least one or more of the portions or zones of the foot that have been successfully scanned. Alternatively, as shown in the Figures, the display can depict not only the zones that have been successfully scanned, but also those zones remaining to be scanned, with the completed zones distinguishable in the display from the remaining zones either through the use of different colors, different line types, different brightness, or similar characteristics.

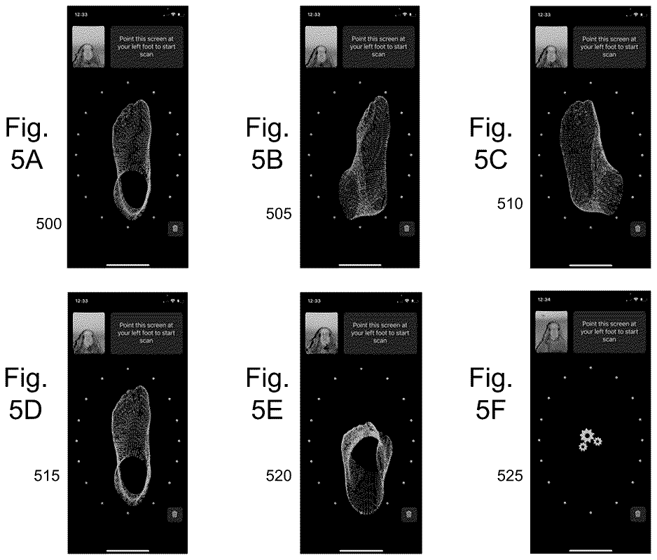

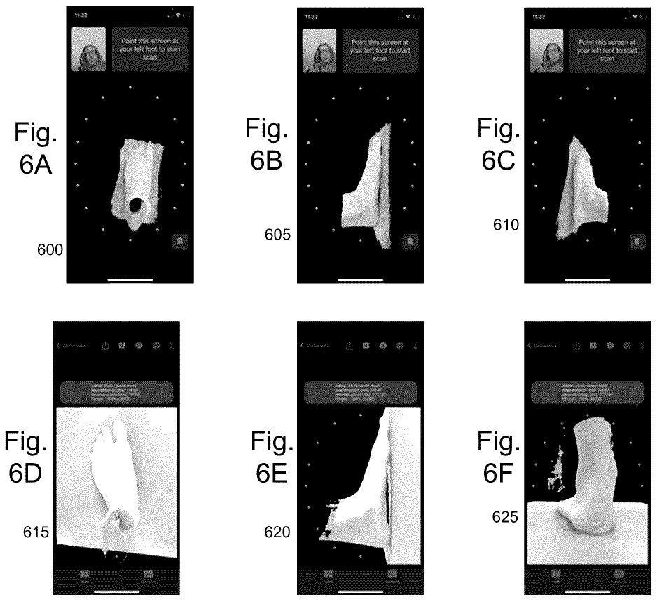

To develop the above-mentioned display, when scanning is stopped or paused, in an embodiment the app of the invention assumes that the mobile device is aligned parallel to a user's feet while they are looking at their screen. This gives a general orientation of the foot relative to the phone and is used to display the 3D Visual Feedback. During such a pause or stop, an algorithm for determining displacement among scans, such as ICP (“Iterative Closest Point”) is run between the captured best_clusters and the point cloud of the generic foot model (left or right foot depending on user selection). The point cloud of the generic foot model preferably has the same voxel size as the captured point clouds. ICP returns a correspondence set. If the correspondence results are bigger than a set threshold, e.g. 50%, all the generic foot points matched from the correspondence set are marked as scanned (e.g. green), see FIG. 3C and FIGS. 5A-5F. The same is done for all the other captured frames. All non matched points from the generic model are marked as not scanned (e.g. red), see FIGS. 6A-6F.

Alternatively, other techniques can be used to detect, label and/or orient a region of the foot and mark the generic foot model as scanned, including machine learning where the training data is a series of scanned or synthetic partial and/or complete foot images, IMU output, or a combination of these methods.

When all the predefined zones/regions/areas have been covered, the scan is considered complete and the auto stop (265, FIG. 2) is triggered and the result is computed. In an embodiment, the result is computed using, for example, pairwise registration via ICP among all saved frames (245, FIG. 2) that have an index difference of, for example, less than 10. Global optimization is performed to align the position and orientation of a set of poses, for example using pose graph. In pose graph registration, the poses are represented as nodes in a graph, and the edges between the nodes represent the relative motion between the poses. The goal of the registration process is to find the optimal configuration of the graph that aligns the poses in a consistent manner, taking into account any measurement noise or uncertainty. A variety of algorithms that can be used to perform pose graph registration, including least squares optimization, maximum likelihood estimation, and probabilistic methods. These algorithms seek to minimize the error between the measured poses and the estimated pose graph, subject to certain constraints. As an alternative to pairwise registration, groupwise registration can be used in at least some embodiments.

To achieve a globally consistent 3D foot model, both rigid and non-rigid point cloud registration methods can be utilized in some embodiments of the invention to align frames. In the case of rigid point cloud registration, the objective is to find the optimal rotation and translation parameters that align two point clouds in a way that minimize some predefined metrics. Rigid point cloud registration methods can include ICP, feature-based methods graph-based methods, volumetric methods, and so on. Feature-Based Methods typically align point clouds by matching distinctive features in the point clouds, such as edges or corners. Examples of feature-based methods include Feature-Based ICP and the Global Registration algorithm. Graph-Based Methods typically align point clouds by constructing a graph representation of the point clouds and finding an optimal alignment by optimizing over the graph. Examples of graph-based methods include the Spectral Registration algorithm and the Go-ICP algorithm. Volumetric Methods typically represent the point clouds as 3D voxel grids and align them by minimizing the difference between the voxel grids. An example of a volumetric method is the Elastic Fusion algorithm

In the non-rigid case, an optimal vector field is estimated to allow different transformations of different regions caused by deformation. Certain regularizations, such as continuity, smoothness, bending, are typically applied to make the estimated deformation more realistic, including satisfying any applicable physical constraints. Non-rigid registration methods include probabilistic methods such as the Coherent Point Drift (CPD) algorithm, which formulates the registration as a probability density estimation problem including the use of Gaussian Mixture Model (GMM) centroids, as well as volumetric methods that are similar to those used in rigid registration. Examples of volumetric methods include Free-Form Deformation (“FFD”), Thin-Plate Spline (“TPS”), and Non-parametric Image Registration (“NIR”), among others.

As a still further alternative to the above-mentioned classic registration methods, deep neural networks (DNNs) can be employed to address the point cloud registration problem. Given a pair of point clouds with known transformation, either rigid or deformable, a deep neural network can be applied to a deep regression between the input point clouds in order to predict the transformation between them. The optimization objective is to minimize the distance between the predicted and known transformation parameters. As in the classical methods, regularization is typically used as an additional term in the optimization process. Synthetic transformation and deformation can also be applied to 3D foot models to generate pairs of foot point clouds to train DNNs for foot specific registration. Foot point clouds with partial overlap can also be simulated to mimic the real scanning process of using depth sensors.

As discussed above, in an embodiment, before, during, and upon completion of a scan, audio and/or haptic feedback is given to users to guide them. In such embodiments, the app of the invention uses input data from the IMU and depth sensor to compute both the distance of the mobile device from the foot, and the angle of the mobile device relative to the foot. Examples of feedback that can be given to the user at various times associated with scanning include:
Distance good, angle good: low Frequency sound, low frequency pulse
Distance good, angle bad: low Frequency sound, no pulse
Distance too close, angle good: high frequency sound, low frequency pulse
Distance too close, angle bad: high frequency sound, no pulse
Distance too far, angle good: no sound, low frequency pulse
Distance too far, angle bad: no sound, no pulse

Depending upon the embodiment, the sound and pulse can vary smoothly or discretely as a function of distance and angle respectively (i.e. sound with linearly increasing frequency as a function of distance, sound with discrete increases in frequencies). As noted above, in some embodiments the 3D space around the foot is broken down into a plurality of zones, for example 16 zones. Each zone is a slice of an elliptical dome. In one embodiment, these 3D zones are represented by a dot positioned on an ellipse around the foot, as shown in FIGS. 3A-3C, 4A-4E, and 5A-5F. Audio feedback in the form of solfege (Do Re Mi Fa Sol La Ti Do) is given to the user each time a threshold amount of information is captured in an associated zone or zones.

Alternatively, the auditory feedback can take the form of spoken words, although some aspects of spoken word guidance are more complex than the use of a note or tone. Considerations involved in determining what auditory or haptic feedback should be provided to guide a user in 3D space, including position and orientation of the mobile device, comprise: selecting a coordinate system (i.e. cartesian, polar, spherical), to enable guiding users based on the x, y, z position and a, b, c orientation of their mobile device, or on the radial distance from the cluster and a, b, c orientation of their mobile device; establishing a pattern/path that must be completed; establishing a suitable number of zones, for example sixteen as discussed above although 30 or more can be acceptable in some applications, with fewer acceptable in other applications; defining anatomical sections, e.g. toes, arch, heel, top, inner/outer sides; establishing 1 O'Clock to 12 O'Clock; conveying a pattern to users before the scan starts; communicating that the scan is complete or communicating that more scanning has to be done; communicating that a section of the pattern is incomplete/is complete; developing spoken word messages brief enough to provide meaningful guidance while still enabling smoothly continuous scanning.

Because scanning of a foot—and especially scanning of a user's own foot—can be challenging for some people, the use of corrective algorithms can be helpful in some embodiments. For example, some areas like the heel can be more difficult to reach, or coming from one side of the foot to the other can require changing hands with the potential for a discontinuity. Excessive movement of the feet can lead to an unsuccessful scan since, as described above, reconstruction methods rely on point clouds being aligned and having overlapping geometries. If the geometry being scanned changes from frame to frame, the lack of consistency among the point clouds can mean the final reconstruction might not be successful.

To improve scanning accuracy and reduce a user's effort, a motion and deformation correction component can be applied in some embodiments. By discarding large inconsistent frames and correcting deformations during the scanning process, useful scanning information can be extracted and integrated into the 3D foot model. This reduces a user's effort when scanning and adds robustness to the process. In an embodiment, non-rigid registration methods such as non-rigid ICP are applied between frames to estimate the deformation vectors associated with a given foot region. If the deformation is within a predetermined threshold, which may vary depending on the foot region, the inverse of the deformation is applied to warp the new frame to the currently reconstructed foot model. Otherwise, the frame is discarded due to the large deformation.

Further, in some embodiments a depth denoising step is applied to enhance the area around the foot. This can be important in some embodiments to undo the unexpected effects caused by post-processed integrated into the mobile device by its manufacturer that alter the depth output. Instead, the prior knowledge of foot and its relation to floor is utilized to build a confidence map of depth values which is then used to remove points with low confidence.

From the foregoing, it will be appreciated that a new and novel method and system for using guided scanning for generating 3d models, including a plurality of alternatives, has been disclosed. Given the teachings herein, numerous other alternatives and equivalents will be apparent to those skilled in the art. Thus, the foregoing specification is not intended to be limiting, and the invention is to be limited only by the appended claims.

What is claimed is:

1. A method for constructing a three-dimensional representation of an individual's foot in a user device having a processor, data storage, a depth sensor and a display comprising the steps of
providing in the display a generic representation of a foot,
providing to a user guidance by which the user orients the depth sensor relative to the individual's foot in three dimensions,
displaying, in the display, a plurality of indicia substantially surrounding at least a portion of the displayed foot to indicate portions of the individual's foot that have not been scanned,
activating the depth sensor in the user device to perform a scan of at least a portion of the individual's foot,
modifying the generic representation of a foot in accordance with the scan to provide an estimation of the areas of the individual's foot that have been successfully scanned,
repeating the guidance, displaying, activating and modifying steps until the individual's foot has been sufficiently scanned that a three-dimensional representation of the individual's foot can be developed.

2. A system for constructing a three-dimensional representation of an individual's foot comprising
a display for showing a generic representation of a foot in response to commands from the processor,
first signal generator responsive to the processor for providing to a user guidance by which the user orients a depth sensor relative to the individual's foot in three dimensions,
second signal generator responsive to the processor for displaying, in the display, a series of indicia substantially surrounding at least a portion of the display of the foot to indicate portions of the individual's foot that have not been scanned,
a depth sensor, responsive to commands from the processor for performing a scan of a portion of the foot,
in the display, in response to commands from the processor, modifying the generic representation of a foot in accordance with the scan to provide an estimation of the areas of the individual's foot that have been successfully scanned.
